(19) United States
(12) Patent Application Publication
(10) Pub. No.: US 2026/0101873 A1
(43) Pub. Date: Apr. 16, 2026

(54) ANIMAL ENRICHMENT KIT

(71) Applicant: The Andersons Inc., Maumee, OH (US)

(72) Inventors: Norman A. Peiffer, Maumee, OH (US); Edward L. Sharek, Maumee, OH (US)

(73) Assignee: The Andersons Inc., Maumee, OH (US)

(21) Appl. No.: 19/358,906

(22) Filed: Oct. 15, 2025

Related U.S. Application Data
(60) Provisional application No. 63/707,245, filed on Oct. 15, 2024.

(51) Int. Cl. A01K 15/02; A01K 1/03

(52) U.S. Cl. CPC A01K 15/026; A01K 1/03

(57) ABSTRACT

An animal enrichment kit including least two of a box having at least one through opening therein configured to induce a sense of security in a laboratory animal by providing an enclosure for the animal; a three-dimensional puck of a plurality of paper strips configured to induce extended play time in the laboratory animal by providing the animal an opportunity to relocate and disassemble said puck into the plurality of paper strips; a plurality of crinkle papers configured to induce extended play time and purpose in the laboratory animal by providing the animal with tunneling and nesting material; a hollow tube configured to induce gnawing by the laboratory animal and provide the animal an opportunity to maintain dental health; and a twisted roll configured to induce extended play time in the laboratory animal by providing the animal an opportunity to disassemble the twisted roll to form a nesting material.

### RELATED APPLICATIONS

This application claims priority benefit of U.S. Provisional Application Ser. No. 63/707,245 filed 15 Oct. 2024; the contents of which are hereby incorporated by reference.

### FIELD OF THE INVENTION

The present invention in general relates to animal products, and in particular to an enrichment kit for confined animals, the enrichment kit including materials that may be used alone and in various combinations to provide an animal with a degree of mental stimulation, nest building opportunities for security and thermoregulation, and opportunities to satisfy normal behaviors such as gnawing, hiding, scavenging, or foraging.

### BACKGROUND OF THE INVENTION

There is a growing body of evidence that domesticated animals and in particular laboratory animals exhibit behaviors that in humans are associated with sensory deprivation, and depression. These abnormal behaviors not only impact the well-being of an individual animal but also have implications in studies involving such an animal owing to the physiological effects of sensory deprivation and depression. In humans, sensory deprivation and depression have an effect on metabolism, cognitive function, immune response and other parameters relevant to clinical studies. The ability to provide a laboratory animal with a degree of mental stimulation is hampered by the requirements of study protocols that attempt to avoid introduction of new reaction variables, as well as the requirement in many instances that only sterilized materials be brought into contact with a laboratory animal. Captive animals deserve an environment which is rich in social opportunity, mental stimulation, physical challenges, and opportunities for physical care. Sterility conditions are typically enforced in instances where an animal has been immunocompromised or otherwise carries a genetic defect rendering an animal vulnerable to disease or infection.

With laboratory study requirements, litter provided to absorb animal urine and desiccate fecal material is one of a limited number of opportunities to provide a source of stimulation to a confined laboratory animal. Prior art attempts have been made to include folded squares of paper with the intention that the animal would occupy time delaminating and chewing or unfolding the small chips of paper. Unfortunately, such attempts met with limited success owing to the disinterest of mice (especially male species) and rats confined within laboratory cages to actually play with the folded squares of paper. The 1985 amendments to the Animal Welfare Act included provisions for the promotion of the psychological well-being of nonhuman primates and for exercise for dogs. Today, many research, teaching, and testing facilities have established environmental enrichment programs for all animal species are representative of this effort.

Enrichment materials provided to laboratory animals facilitate activities and purpose for the animals with the proviso that such materials do not expose the animal to substances that could impact study data integrity. Enrichment materials illustratively include toys, cardboard tunnels, cardboard enclosures, gnawing blocks, exercise equipment, litter, and nesting materials. Examples of nesting materials illustratively include aspen shavings, cotton squares, rolled paper and pellets, paper strips, and a puck formed from compressed paper strips as disclosed in U.S. Pat. No. 9,398,757; to The Andersons, Inc., which incorporated herein by reference in its entirety. Enrichment materials encourage laboratory animals to exhibit their natural instincts to produce or seek shelter and provide the animals with a degree of control over their environment. These positive behaviors lead to improved brain and neuronal development and reduce undesirable traits and behaviors in the animals including aggressive behavior and fighting, stereotypies, and barbering. Stereotypes are repetitive movements or sounds, and in lab animals typically include simple movements such as body-rocking and head-nodding, or more complex movements, such as pacing. Barbering is defined as abnormal whisker and fur plucking behavior commonly seen in mice and is thought to be associated with an expression of social dominance.

Nest building is a natural activity of rodents, especially mice. Nest building is a form of psychological enrichment and a vital part of needs for a mouse environment. Mice tend to be most comfortable at a temperature of 30 degrees Celsius. Often laboratories housing mice are maintained at a temperature of 21 to 24 degrees Celsius. Mice build nests in order to thermoregulate. Through the maintenance of mice at a comfortable temperature, mice consume less food, have higher pup yields, and experience less overall stress.

Gnawing is yet another behavior of rodents that is important for their overall health and wellbeing. Rodents have incisors that never stop growing, so there is a need to chew. Gnawing and bruxing, or soft repetitive grinding of the incisors against one another serve to keep the incisors trimmed. If these constantly growing incisors are not trimmed, they can cause improper alignment of teeth and trauma to the saft palate, infection, and abscesses, which in turn hinders the rodent's ability to groom, move, and eat, leading eventually to starvation. Other types of animals, including fish also suffer from a lack of enrichment in not only laboratory settings, but also in the context of being kept as pets or zoological exhibits.

While there have been many advancements in enrichment materials and improvements for the quality of living conditions for laboratory animals there continues to be a need for further efficiencies in laboratory set up for animals that also provide for improvements in the well-being of the animals, as well as, efficient distribution to animal cages and usage of materials all while adhering to requirements of study protocols that attempt to avoid introduction of new reaction variables.

Thus, there exists a need for an animal enrichment kit that provides a limited number of materials to reduce introduction of reaction variables to laboratory studies while ensuring that the materials included may be used alone and in various combinations to provide numerous opportunities for engaging the attention of a laboratory animal to provide mental stimulation, nest building opportunities for security and thermoregulation, and opportunities to satisfy common gnawing, hiding, and foraging behaviors to occupy time and alleviate some of the symptoms associated with sensory deprivation and thermal dysregulation.

### SUMMARY OF THE INVENTION

The present invention provides an animal enrichment kit including least two of a box having at least one through opening therein configured to induce a sense of security in a laboratory animal by providing an enclosure for the animal; a three-dimensional puck of a plurality of paper strips configured to induce extended play time in the laboratory animal by providing the animal an opportunity to relocate and disassemble said puck into the plurality of paper strips; a plurality of crinkle papers configured to induce extended play time and purpose in the laboratory animal by providing the animal with tunneling and nesting material; a hollow tube configured to induce gnawing by the laboratory animal and provide the animal an opportunity to maintain dental health; and a twisted roll configured to induce extended play time in the laboratory animal by providing the animal an opportunity to disassemble the twisted roll to form a nesting material.

The present invention additionally provides an animal enrichment kit that includes at least two of: a piece of box material, a three-dimensional puck of a plurality of paper strips, a plurality of crinkle papers, a hollow tube, and a twisted roll. According to embodiments, the box material is configured to be folded into a box having at least one through opening therein, according to some embodiments without the use of an adhesive or fasteners. The box, when present, being configured to induce a sense of security in a laboratory animal by providing an enclosure for the animal. According to embodiments, the three-dimensional puck of a plurality of paper strips, when present, is configured to induce extended play time in the laboratory animal by providing the animal an opportunity to relocate and disassemble said puck into the plurality of paper strips. The plurality of crinkle papers, when present, are configured to induce extended play time and purpose in the laboratory animal by providing the animal with tunneling and nesting material. The hollow tube, when present, is configured to float and/or to induce gnawing by the laboratory animal and provide the animal an opportunity to maintain dental health. The twisted roll, when present, is configured to induce extended play time in the laboratory animal by providing the animal an opportunity to disassemble the twisted roll to form a nesting material. According to embodiments, when both are present, the hollow tube has a diameter that is larger than the diameter of the twisted roll.

### BRIEF DESCRIPTION OF THE DRAWINGS

FIG. 1 is a perspective view of enrichment items of an animal enrichment kit according to embodiments of the present invention; and

FIG. 2 is a top view of a piece of box material that configured to be folded into a box according to embodiments of the present invention.

### DESCRIPTION OF THE INVENTION

The present invention has utility as an animal enrichment kit that provides a limited number of laboratory acceptable materials to reduce introduction of reaction variables to laboratory studies while ensuring that the materials included may be used alone and in various combinations to provide numerous opportunities for engaging the attention of a laboratory animal to provide mental stimulation, nest building opportunities for security and thermoregulation, and/or opportunities to satisfy normal behaviors such as gnawing, hiding, and/or foraging behaviors to occupy time and alleviate some of the symptoms associated with sensory deprivation and thermal dysregulation.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which does not depart from the instant invention. Hence, the following specification is intended to illustrate some particular embodiments of the invention and not to exhaustively specify all permutations, combinations, and variations thereof.

It is to be understood that in instances where a range of values is provided, the range is intended to encompass not only the endpoint values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting to the invention.

Unless indicated otherwise, explicitly or by context, the following terms are used herein as set forth below.

As used in the description of the invention and the appended claims, the singular forms “a,” “an,” and “the” are intended to include the plural forms as well unless the context clearly indicates otherwise.

Also, as used herein, “and/or” refers to and encompasses any and all possible combinations of one or more of the associated listed items, as well as the lack of combinations when interpreted in the alternative (“or”).

As used herein, the term “paper strip” is defined to include at least one ply of fibrous material. The fibrous material illustratively includes cellulose, alkoxylated cellulose, alginate, starch, polyethylene, polypropylene, polyvinyl, polystyrene, Spandex, Lycra, rubber, fleece, cellulose pulp, cellulose pulp derivatives, or any combinations thereof. The paper strips being planar, crinkled, twisted, rolls, and combinations thereof.

As used herein, an “animal” is defined to include a rodent such as a mouse, rat, hamster, gerbil, and rabbit; a bird such as a quail, chicken, turkey, parrot, parakeet, canary, and finch: felines, such as domesticated cats; a primate such as a monkey, chimpanzee, and gorilla; and fish, such as zebra fish.

According to embodiments, the animal enrichment kit 10 includes at least two of the following enrichment items: a box 30 having at least one through opening 32 therein; a three-dimensional puck 40 of a plurality of paper strips 42; a plurality of crinkle papers 50; a hollow tube 60 having a first diameter; and a twisted roll 70 having a second diameter that is smaller than the first diameter of the hollow tube 60. The present invention balances study protocols that attempt to avoid introduction of new reaction variables with animal enrichment requirements and goals for maintaining physically and mentally healthy laboratory animals by providing an enrichment kit with at least two enrichment items. Notably, it is an important feature of the inventive enrichment kit 10 that each enrichment item introduced to an environment is able to provide multiple enrichment functions. That is, each enrichment item included in any embodiment of the inventive enrichment kit 10 has at least one primary enrichment function, i.e. an enrichment function when used on its own, and at least one additional secondary enrichment function, i.e. an enrichment function when used with another enrichment item. Accordingly, the inventive enrichment kit is a configurable, versatile kit customizable for the particular enrichment needs of a given animal or study protocol, resulting in a kit that is more than merely the sum of its parts. Table 1 below shows the primary enrichment functions of each enrichment item alone and the secondary enrichment functions of each enrichment item in combination with the other enrichment items.

TABLE 1
Enrichment Items and Enrichment Functions.

| | Primary | Enrichment Item | | | | |
|---|---|---|---|---|---|---|
| | Enrichment | | | Crinkle | Hollow | Twisted |
| | Functions | Box | Puck | Paper | Tube | Roll |
| Enrichment | Box | Enclosure | Packaging | Packaging | Packaging | Packaging |
| Function | | Gnawing | Nesting | Scavenging | Problem | Scavenging |
| Combinations | | Deconstruct | Thermal | Nesting | solving | Nesting |
| | | | Regulation | | | |
| | Puck | Packaging | Play | Nesting | Hide/find | Hide/find |
| | | Nesting | Deconstruct | Tunneling | Problem | |
| | | Thermal | | Thermal | solving | |
| | | Regulation | | Regulation | | |
| | Crinkle | Packaging | Nesting | Play | Hide/find | Hide/find |
| | Paper | Scavenging | Tunneling | Tunneling | Problem | Scavenging |
| | | Nesting | Thermal | Nesting | solving | |
| | | | Regulation | | | |
| | Hollow | Packaging | Hide/find | Hide/find | Play | Hide/find |
| | Tube | Problem | Problem | Problem | Gnawing | Problem |
| | | solving | solving | solving | | solving |
| | Twisted | Packaging | Hide/find | Hide/find | Hide/find | Play |
| | Roll | Scavenging | | Scavenging | Problem | Deconstruct |
| | | Nesting | | | solving | |

According to some inventive embodiments, the animal enrichment kit 10 includes a box 30 having at least one through opening 32 therein. According to still other inventive embodiments, a primary enrichment function of the box 30 is that it is configured to induce a sense of security in a laboratory animal by providing an enclosure, shelter, and protection for the animal. According to still other inventive embodiments, an additional primary enrichment function of the box 30 is that it provides the animal with a degree of mental stimulation in that it allows the animal to chew on and/or deconstruct the box. According to embodiments, the box 30 is formed of lava stone or calcium stone, allowing the animal to chew and gnaw on the box 30 in order to grind the animal's teeth, thereby maintaining the health and well-being of the animal; this is particularly useful when the animal is a rodent or guinea pig.

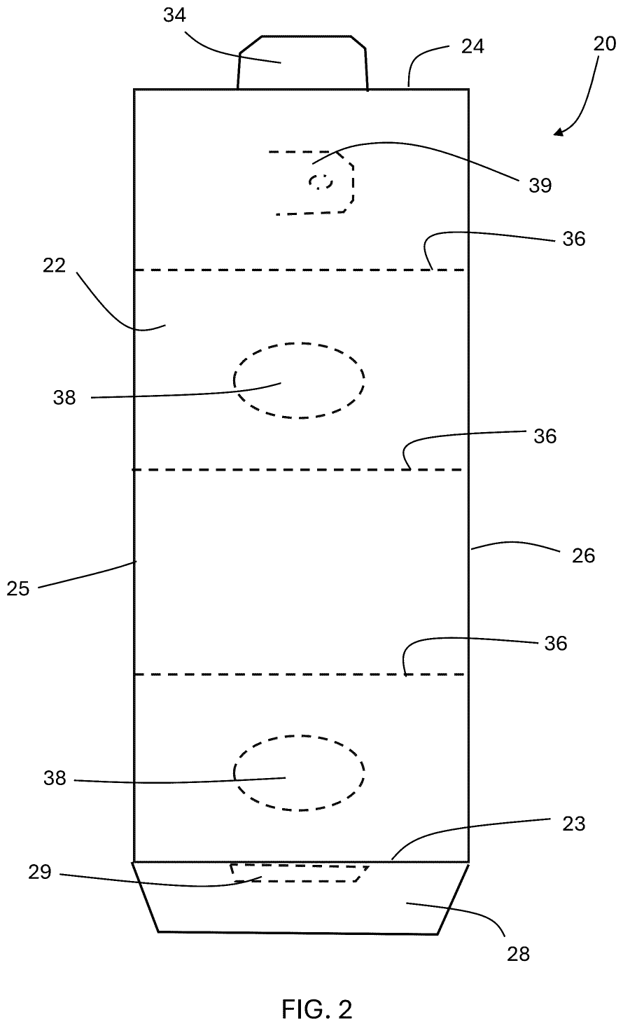

According to embodiments, the box is formed of a piece of box material 20 that is configured to be folded into the box 30. According to such embodiments, the piece of box material 20 is formed of cardboard or a water-resistant material, thereby allowing the box to be submerged in a water environment for a period of time without deteriorating. According to still other inventive embodiments, the piece of box material 20 is formed of a single piece of material that is configured to be folded relative to itself to form the box 30. As shown in FIG. 2, the piece of box material 20 includes a rectangular portion 22 having a first end 23, a second end 24, a first edge 25, and a second edge 26. At the first end 23 a flap 28 extends from the rectangular portion 22. At an interface between the flap 28 and the first end 23, the flap 28 defines a cutout 29. The cutout 29 corresponds in shape and size to a tab 34 that extends from the second end 24 of the rectangular portion 22 of the piece of box material 20. According to still other inventive embodiments, the rectangular portion 20 includes a plurality of fold lines 36 at which the piece of box material 20 is to be folded to form the box 30. To form the box 30, the rectangular portion 22 is folded along the fold lines 36 and the tab 34 is inserted into the cutout 29 defined in the flap 28. Thus, the box material 20 is configured to be folded into the box 30 without use of any adhesive or fasteners, thereby reducing items introduced into the animal environment. According to still other inventive embodiments, the rectangular portion 22 of the box material 20 additionally includes at least one additional cutout 38 configured to form a through hole in the box 30. According to still other inventive embodiments, the box material 20 additionally includes a hanger portion 39 that is configured to be bent out from the rectangular portion 22. According to still other inventive embodiments, the box material 30, when present in the kit 10 may be provided flat and configured for assembly into the box 30 only prior to use of the enrichment kit 10, or according to other still other inventive embodiments, the box 30 is provided pre-formed in order to contain a remainder of the enrichment items in the enrichment kit 10.

According to still other inventive embodiments, the assembled box 30 forms a square tube with a length of about 5 inches, a width of about 3 inches, and a height of about 3 inches. According to embodiments, the box material 20 is corrugated or fluted, according to some inventive embodiments.

According to still other inventive embodiments, the animal enrichment kit 10 includes a three-dimensional puck 40 of a plurality of paper strips 42 compressed in a mold to form the three-dimensional puck 40, the disentanglement of which provides an animal with a degree of mental stimulation and nest construction. It has been surprisingly found that a compressed mass three-dimensional puck 40, when present in the inventive enrichment kit 10, provides multiple benefits to the animal including mental stimulation and activity generation, nesting material, and also improved thermal regulation. Additionally, the pre-measured quantum of material in the three-dimensional puck 40 affords a benefit to the caregiver in that the product is simply placed in the cage environment without resort to measuring and thereby saving time and precluding spillage of separated materials. With the animal occupied and thermally regulated, it is noted that animal food consumption and health are generally improved. Embodiments of the inventive enrichment kit 10 that includes a three-dimensional puck 40 are particularly beneficial to rodents and especially mice.

The deconstruction of the three-dimensional puck 40 by an animal into constituent paper strips 42 provides the animal with an activity that occupies time and appears to alleviate behaviors associated with cage confinement. The resultant decompressed strips 42 are routinely fashioned into nesting material by animals. In addition, the animal is able to push or carry the three-dimensional puck 40 to different areas of the cage. In an instance where more than one three-dimensional puck 40 is introduced to the animal's environment, the animal can collect the three-dimensional pucks 40 or distribute the three-dimensional pucks 40 around their cage.

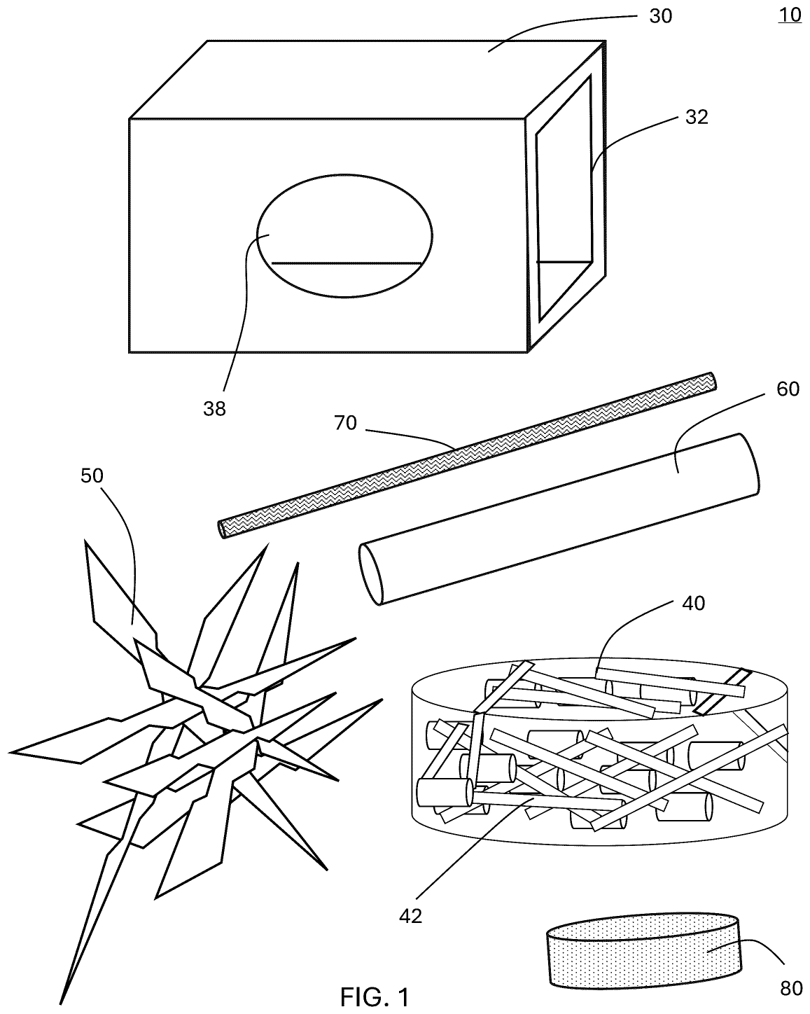

According to still other inventive embodiments, the paper strips 42 may have a height to length ratio from 1:1 to 1:200; and in still other inventive embodiments from 1:5 to 1:50 with the understanding that other height to length ratios depending on the overall dimensions of the three-dimensional shapes are operative herein. FIG. 1 shows a perspective view of a three-dimensional puck 40 formed with compressed paper strips 42. It is appreciated that the term “puck” also includes shapes other than right cylinders and also include rectilinear forms, spheroids, polygonal forms, and geometrically irregular forms. The puck 40 as shown in FIG. 1 can have smooth or frayed edges. The thickness of the paper strips 42 may typically be between 0.07 millimeters (0.0028 in) and 0.18 millimeters (0.0071 in). It is also appreciated that according to the present invention, depending on the size of the animal, the thickness of the paper strip 42 is increased beyond these values.

The paper strip 42 component of the three-dimensional puck 40 is amenable to incorporation of various adjuvants operative to enhance performance and/or entertainment value of the three-dimensional puck 40. Adjuvants suitably incorporated into the paper strip 42 component of an three-dimensional puck 40 illustratively include fragrances; dyes; odor suppressants such as baking soda; superabsorbent polymer granules; flavorants such as sugar and fruit flavors; and nutrients. In the instance where a paper strip 42 component includes entertainment value enhancing adjuvants such as dyes or flavorants, it is appreciated that the stimulation value is enhanced by irregular distribution of the adjuvant. Irregular distribution is readily achieved by exposing the pile of paper strips 42 used to form the three-dimensional puck 40 for an amount of time sufficient to create an incomplete penetration of the adjuvant into the three-dimensional shapes. It is appreciated that an adjuvant is readily applied in the form of a solid, liquid, or solution with excess moisture being removed to arrive at a three-dimensional shape component moisture component with a preselected level. The use of dyes allows for coloration of the three-dimensional puck 40, where pucks 40 can have different coloration such as white, natural, or colored to further peak the interest of the subject animal.

In some embodiments of the invention three-dimensional pucks 40 are formed by compressing a pile of paper strips 42 in a mold. As shown in FIG. 1, the pile of paper strips 42 is composed of a random stack of paper strips 42, which when compressed in a mold form the desired three-dimensional shape of the puck 40 with a resulting mass of randomly oriented and intertwined paper strips 42. To aid in the forming and retention of the shape during and after the release from the mold, the paper strips 42 may be wetted with water or other alternative liquids.

In a particular inventive embodiment, the puck 40 has a mean height between 25.4 millimeters (0.1 in) and 254 millimeters (1.0 in). The diameter of the puck 40 may vary, for example between 127 millimeters (0.5 in) and 508 millimeters (2.0 in), with a typical ratio between diameter and height of between 2:1 and 30:1. It is appreciated that the mean height and diameter of the puck 40 is chosen with recognition as to the size and dexterity of the animal using the inventive puck 40. For example, much larger dimensions would be required for a puck 40 for use with a primate. It is appreciated that various other three-dimensional shapes are also sized based on the intended end user.

An animal, when provided with an embodiment of the inventive kit 10 that includes a puck 40 is able to engage in activity to reduce boredom, anxiety, and stress; as well experiencing enhanced mental stimulation. An animal is also noted to have better thermal regulation upon deconstruction of a three-dimensional puck 40 into constituent strips 42 and therefore have lower overall food consumption. The activity involves relocation of one or more supplied three-dimensional pucks 40 and systematic turning and unfolding of the three-dimensional puck 40 to yield individual paper strips 42.

An animal exposed to an embodiment of the inventive kit 10 that includes a puck 40, in particular a rodent, is observed to initially begin chewing the three-dimensional puck 40. Upon the animal discovering that the three-dimensional puck 40 begins to unravel into strips of paper 42, animal handling and chewing of a three-dimensional puck 40 becomes purposeful with the intent of rendering a three-dimensional puck 40 as a collection of paper strips 4. The strips 42 formed from unfolding the one or more three-dimensional puck 40 are then taken by the animal to be used to form a hiding place as well as bedding, for example within the box 30, when the kit 10 includes the box 30. The paper strips 42 obtained from the three-dimensional puck 40 replaces manufactured rigid hiding places with more instinctively sought and natural materials to the animal. A surprising aspect of kits 10 that include the puck 40 is that male rodents, which are more likely to exhibit abhorrent and antisocial behavior, are also observed to engage in apparent play behavior with the paper strips 42 of the three-dimensional puck 40. The periodic inclusion of flavorant patches and to a lesser extent colorimetric zones along the length of a paper strip 42 is noted to enhance animal interest in the puck 40.

When the three-dimensional puck 40 is included in embodiments of the inventive kit 10, the paper strips 42 of the puck 40 can be brought into the box 30 for nesting and thermal regulation, incorporated with crinkle papers 50 for nesting or play material, shoved into or pulled out of the hollow tube 60, or used to hide the twisted roll 70 for a hide and find activity.

According to embodiments, the animal enrichment kit 10 includes a plurality of crinkle papers 50. According to embodiments, a primary enrichment function of the plurality of crinkle papers 50 is that they are configured to induce extended play time and purpose in the laboratory animal by providing the animal with tunneling and nesting material. According to embodiments, an additional primary enrichment function of the plurality of crinkle papers 50 is that they provide the animal with a degree of mental stimulation in that it allows the animal to chew on the crinkle papers 50.

It has been surprisingly found that the plurality of crinkle papers 50, when present in the inventive enrichment kit 10, provide multiple benefits to the animal including mental stimulation and activity generation, nesting material, and also improved thermal regulation. With the animal occupied and thermally regulated, it is noted that animal food consumption and health are generally improved. Embodiments of the inventive enrichment kit 10 that includes the plurality of crinkle papers 50 are particularly beneficial to rodents and especially mice. The interaction with the plurality of crinkle papers 50 by an animal provides the animal with an activity that occupies time and appears to alleviate behaviors associated with cage confinement. The plurality of crinkle papers 50 are routinely fashioned into nesting material by animals. In addition, the animal is able to push or carry the plurality of crinkle papers 50 to different areas of the cage, thereby satisfying a scavenging instinct in the animal.

According to embodiments, the plurality of crinkle papers 50 are formed of at least one ply of fibrous material, such as cellulose, alkoxylated cellulose, alginate, starch, polyethylene, polypropylene, polyvinyl, polystyrene, Spandex, Lycra, rubber, fleece, cellulose pulp, cellulose derivatives, or any combinations thereof. The thickness of the plurality of crinkle papers 50 may typically be between 0.07 millimeters (0.0028 in) and 0.18 millimeters (0.0071 in). It is also appreciated that according to the present invention, depending on the size of the animal, the thickness of the plurality of crinkle papers 50 is increased beyond these values. According to embodiments, the plurality of crinkle paper 50 have a width of between 5 to 10 mm, which has been surprisingly found to reduce the likelihood of animal strangulation, that was found to occur when the crinkle papers 50 were of a smaller width. According to some embodiments, the crinkle papers 50 are provided as strips, i.e. having a length larger than the width, or a paper squares.

The crinkle apers 50 are amenable to incorporation of various adjuvants operative to enhance performance and/or entertainment value thereof. Adjuvants suitably incorporated into the crinkle papers 50 illustratively include fragrances; dyes; odor suppressants such as baking soda; superabsorbent polymer granules; flavorants such as sugar and fruit flavors; and nutrients. In the instance where the crinkle papers 50 include entertainment value enhancing adjuvants such as dyes or flavorants, it is appreciated that the stimulation value is enhanced by irregular distribution of the adjuvant. Irregular distribution is readily achieved by exposing the crinkle papers 50 for an amount of time sufficient to create an incomplete penetration of the adjuvant into the crinkle papers 50. It is appreciated that an adjuvant is readily applied in the form of a solid, liquid, or solution with excess moisture being removed. The use of dyes allows for coloration of the crinkle papers 50 such as white, natural, or colored to further pique the interest of the subject animal.

According to embodiments, the plurality of crinkle papers 50 include 2 to 200 individual pieces of crinkle paper 50. An animal, when provided with an embodiment of the inventive kit 10 that includes crinkle papers 50 is able to engage in activity to reduce boredom, anxiety, and stress; as well experiencing enhanced mental stimulation. An animal is also noted to have better thermal regulation upon use of the crinkle papers 50 as bedding and therefore have lower overall food consumption.

An animal exposed to an embodiment of the inventive kit 10 that includes crinkle papers 50, in particular a rodent, is observed to initially begin chewing the crinkle papers 50. Upon the animal discovering that the crinkle papers 50 are separable, individual strips, animal handling and chewing of the crinkle papers 50 becomes purposeful. The crinkle papers 50 are then taken by the animal to be used to form a hiding place as well as bedding, for example within the box 30, when the kit 10 includes the box 30. A surprising aspect of kits 10 that include the crinkle papers 50 is that male rodents, which are more likely to exhibit abhorrent and antisocial behavior, are also observed to engage in apparent play behavior with the crinkle papers 50. The periodic inclusion of flavorant patches and to a lesser extent colorimetric zones along the length of a crinkle papers 50 is noted to enhance animal interest in the crinkle papers 50.

When the crinkle papers 50 are included in embodiments of the inventive kit 10, the crinkle papers 50 can be brought into the box 30 for nesting and thermal regulation, incorporated with paper strips 42 of the puck 40, shoved into or pulled out of the hollow tube 60, or used to hide the twisted roll 70 for a hide and find activity.

According to embodiments, the animal enrichment kit 10 includes a hollow tube 60 having a first diameter. According to embodiments, a primary enrichment function of the hollow tube 60 is that it is configured to induce extended play time and induce gnawing by the laboratory animal and provide the animal an opportunity to maintain dental health. According to embodiments, an additional primary enrichment function of the hollow tube 60 is that it provides the animal with a degree of mental stimulation in that it allows the animal to explore and play with the hollow tube 60. According to embodiments, the hollow tube 60 is formed of cardboard. According to embodiments, the hollow tube 60 is formed of a natural reed. According to embodiments, the hollow tube 60 is formed of a water-resistant material, thereby allowing the tube 60 to be submerged in a water environment for a period of time without deteriorating.

According to embodiments, the inner diameter of the hollow tube is 0.25 to 1 inch. According to embodiments, the hollow tube 60 has a length of 3 to 7 inches.

When the hollow tube 60 is included in embodiments of the inventive kit 10, the hollow tube 60 can be brought into the box 30 for a hide and find game and problem solving activity, can be used to hide and find the paper strips 42 of the puck 40, the crinkle papers 50, or the twisted roll 70. The ability to hide and find objects, including the paper strips 42, the crinkle papers 50, and the twisted roll 70, as well as treats or food within the hollow tube 70 give the animal an opportunity to satisfy a scavenging and foraging instinct.

It has been found that kits 10 that include a hollow tube 60 are particularly well suited for rodents and for fish. The rodents have been observed to gnaw on the hollow tube 60 to satisfy the gnawing instinct thereby maintaining dental and overall health. Fish, such as zebra fish, have been observed to enjoy playing with the hollow tube 60, particularly because zebra fish typically remain near the surface of the water of a tank and the hollow tube 60 floats, thereby providing an opportunity for play and stimulation near the water's surface where the fish feel the most comfortable. Given that typical enrichment items in a fish tank are located near the bottom of the tank, surface dwellers, such as zebra fish, typically do not feel comfortable utilizing the enrichment items located at the bottom of the tank. According to some embodiments, the hollow tube 60 has a positive buoyance and therefore floats near the water's surface, as described above. According to other embodiments, the hollow tube 60 has a neutral buoyancy and is therefore suspended intermediate in the water column. According to sill further embodiments, the hollow tube 60 has a negative buoyancy and therefore sinks to the bottom of a fish tank. According to some embodiments, the hollow tube 60 is provided with a pair of weighted rings that can be placed on the outside of the tube 60 in order to weight the hollow tube 60 to cause the tube to sink. According to further embodiments, the hollow tube 60 initially has a positive buoyancy such that it initially floats near the water's surface. Then over time, as the material of the hollow tube 60 takes on water, the buoyancy changes from positive to negative, thereby causing the hollow tube 60 to sink, thereby providing a dynamic and mentally engaging enrichment item for the caged animal.

According to embodiments, the animal enrichment kit 10 includes a twisted roll 70 having a second diameter that is smaller than the first diameter of the hollow tube 60. According to embodiments, a primary enrichment function of the twisted roll 70 is that it is configured to induce extended play time in the laboratory animal by providing the animal an opportunity to disassemble the twisted roll 70 to form a nesting material and to induce extended play time. According to embodiments, an additional primary enrichment function of the hollow tube 60 is that it provides the animal with a degree of mental stimulation in that it allows the animal to explore problem solve how to deconstruct the twisted roll 70. According to embodiments, the twisted roll 70 is formed of twisted paper material, such as cellulose, alkoxylated cellulose, alginate, starch, polyethylene, polypropylene, polyvinyl, polystyrene, Spandex, Lycra, rubber, fleece, cellulose pulp, cellulose derivatives, or any combinations thereof. According to embodiments, the twisted roll 70 is formed of a water-resistant material, thereby allowing the twisted roll 70 to be submerged in a water environment for a period of time without deteriorating.

According to embodiments, the outer diameter of the twisted roll 70 is less than the inner diameter of the hollow tube 60. According to embodiments, the twisted roll 70 has a length of 4 to 8 inches.

When the twisted roll 70 is included in embodiments of the inventive kit 10, the twisted roll 70 can be brought into the box 30 for a hide and find game and problem solving activity, can be used to hide and find within the paper strips 42 of the puck 40, the crinkle papers 50, or the hollow tube 60. The ability to deconstruct the twisted roll 70 into a nesting material gives the animal an opportunity to satisfy a scavenging and foraging instinct.

According to embodiments, the animal enrichment kit 10 includes at least one additional enrichment, environmental, and/or health and hygiene item for a caged animal. According to embodiments, at least one additional item includes at least one of treats, snacks, and food; water; bedding material; crinkle paper squares; twisted paper; twisted paper with cob; cob; a toys; a wooden tongue depressor; a wooden block; a wooden dowel; and a tooth grinding block.

According to embodiments in which treats, food, or snacks are provided with the enrichment kit 10, the treats, food, or snacks may be provided in a bulk container or in pre-portioned amounts. The pre-portioned amounts afford the benefit to the caregiver in that the pre-portioned amount of treats, snacks, or food is simply placed in the cage environment without resort to measuring and thereby saving time and precluding over feeding. According to some embodiments, a pouch is additionally provided with the treats, snacks, or food so that they can be placed inside the pouch, the pouch given to the animal in the cage, and the animal in the cage can engage in a scavenging activity to retrieve the treats, snacks, or food from the pouch. Similarly, the treats, snacks, or food when provided with the kit 10 can be placed inside other components of the kit 10 such as the hollow tube 60 or the box 30 in order to encourage the animal to forage for the food, thereby providing mental stimulation to the animal.

According to embodiments in which bedding material is provided with the kit 10, the bedding can be a pre-measured quantum of material that affords a benefit to the caregiver in that the product is simply placed in the cage environment without resort to measuring and thereby saving time and precluding spillage of separated materials. Similarly, when the kit 10 includes water, the water can be pre-portioned to expedite care of the animal. According to some embodiments, the water, when provided with the kit 10, is a gelled water. Gelled water is a product that can change the texture of water or other liquids. It is used to make hydration safer and easier by making it easier to swallow. Gelled water is soluble at room temperature and is stable at different pH levels, as well as after heating and cooling. Some gelled water products come in different flavors and with or without sugar. Thus, according to embodiments, the inventive kit 10 is a kit of convenience, optionally providing bedding, shelter, water, and food for a caged animal.

According to embodiments in which the enrichment kit 10 includes a tooth grinding block 80, the block 80 is optionally formed of wood, lava block, or mineral calcium stone. Inclusion of a tooth grinding block is particularly useful for enrichment kits 10 intended for rodents, hamsters, and guinea pigs in order to facilitate healthy griding down of the animal's teeth.

The enrichment items of the kit 10 are in certain embodiments amenable to sterilization for use in conjunction with immuno-compromised or genetically mutated laboratory animal models for disease. The sterilization techniques operative with the enrichment items of the kit 10 illustratively include gamma radiation including from a cobalt-60 source and thermal sterilization techniques such as those involving superheated steam or heated air.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An animal enrichment kit comprising at least two of:
a box having at least one through opening therein, the box configured to induce a sense of security in a laboratory animal by providing an enclosure for the animal;
a three-dimensional puck of a plurality of paper strips configured to induce extended play time in the laboratory animal by providing the animal an opportunity to relocate and disassemble said puck into the plurality of paper strips;
a plurality of crinkle papers configured to induce extended play time and purpose in the laboratory animal by providing the animal with tunneling and nesting material;
a hollow tube configured to induce gnawing by the laboratory animal and provide the animal an opportunity to maintain dental health; and
a twisted roll configured to induce extended play time in the laboratory animal by providing the animal an opportunity to disassemble the twisted roll to form a nesting material.

2. The animal enrichment kif of claim 1 wherein the box material, when present, is formed of carboard, lava stone, or calcium stone.

3. The animal enrichment kit of claim 1 wherein the box material, when present, is formed of a single piece of material that is configured to be folded relative to itself to form the box.

4. The animal enrichment kit of claim 1 wherein the box material, when present, is configured to contain a remainder of enrichment items of the kit prior to use.

5. The animal enrichment kit of claim 1 wherein the box material, when present, includes at least one cutout configured to form a through hole in the box.

6. The animal enrichment kit of claim 1 wherein the box material, when present, is configured to be folded into the box without use of any adhesive or fastener.

7. The animal enrichment kit of claim 1 wherein the three-dimensional puck, when present, is formed of compression of the plurality of paper strips in a mold.

8. The animal enrichment kit of claim 1 wherein the plurality of paper strips of the three-dimensional puck, when present, comprise at least one ply of fibrous material.

9. The animal enrichment kit of claim 1 wherein the plurality of paper strips of the three-dimensional puck, when present, have a height to length ratio from about 1:1 to about 1:200.

10. The animal enrichment kit of claim 1 wherein the plurality of paper strips of the three-dimensional puck, when present, have a thickness between 0.07 millimeters and 0.18 millimeters.

11. The animal enrichment kit of claim 1 wherein the plurality of crinkle papers, when present, comprise at least one ply of fibrous material.

12. The animal enrichment kit of claim 1 wherein the plurality of crinkle papers, when present, have a width of between 5 to 10 mm.

13. The animal enrichment kit of claim 1 wherein the hollow tube, when present, is formed of a natural reed.

14. The animal enrichment kit of claim 1 wherein the hollow tube, when present, is formed of cardboard.

15. The animal enrichment kit of claim 1 wherein the twisted roll, when present, is formed of a twisted paper.

16. The animal enrichment kit of claim 1 wherein the twisted roll, when present, has a length of 20 cm.

17. The animal enrichment kit of claim 1 further comprising at least one of treats, snacks, and food; water; bedding material; crinkle paper squares; twisted paper; twisted paper with cob; cob; a toys; a wooden tongue depressor; a wooden block; a wooden dowel; and a tooth grinding block.

18. The animal enrichment kit of claim 1 wherein the kit is amenable to sterilization by irradiation.

19. An animal enrichment kit comprising at least two of:
a piece of box material configured to be folded into a box having at least one through opening therein;
a three-dimensional puck of a plurality of paper strips;
a plurality of crinkle papers;
a hollow tube having a first diameter; and
a twisted roll having a second diameter that is smaller than the first diameter of the hollow tube.

20. The animal enrichment kit of claim 19 wherein each of the box material, the hollow tube, and the twisted roll, when present is formed of a water-resistant material.
